(19) United States
(12) Patent Application Publication
(10) Pub. No.: US 2012/0180299 A1
(43) Pub. Date: Jul. 19, 2012

(54) INTEGRITY OF THE UNION BETWEEN COMPONENTS

(75) Inventor: Rodney Warwick Sharp, Hamilton (NZ)

(73) Assignee: PROGRESSIVE IP LTD., Hamilton (NZ)

(21) Appl. No.: 13/383,366

(22) PCT Filed: Jul. 12, 2010
(86) PCT No.: PCT/NZ2010/000145

§ 371 Date: Apr. 10, 2012

(30) Foreign Application Priority Data
Jul. 10, 2009 (NZ) 578315

(51) Int. Cl. B23P 11/02; B32B 3/06

(52) U.S. Cl. 29/447; 428/141

(57) ABSTRACT

An improved method of shrink fit assembly of two components increases resistance to torsional and/or axial loads without the need for a separate key element. Use of a roughened surface, in combination with a softer deformable material, creates a keyed type interaction at the contact areas of the shrink fitted components. One of the shrink fitted components may include the softer material, though intermediate layers and sleeves can be used.

### FIELD OF INVENTION

The present invention is directed to a method for increasing the bond, and decreasing the likelihood of slipping, between shrink fitted components.

### BACKGROUND DESCRIPTION

Shrink-fitting is a common technique for fitting components, and generally ensures a tighter union than interference fit items. In shrink fitting a temperature differential is created between parts to be fitted—e.g. one component is heated, or one element is cooled. The degree of heating or cooling depends on the coefficient of expansion of the component, and sometimes one component may be heated, while the other is cooled. The heating or cooling causes the elements to expand or shrink and enable them to be fitted. Upon returning to normal temperatures a tight fit is generated. An example might be a sleeve or piston shrink fitted to a cylindrical shaft. The shaft could be cooled, and/or the sleeve heated and then assembled. When returning to normal temperature a tighter union is formed than could be formed from press-fitting alone.

In practice, some shrink fitted components are subjected to high rotational torques. Despite the tightness of a shrink fitted union, rotation of one component relative to the above may occur about the join. In practice, this is commonly addressed by machining the components to accept a key which prevents rotation.

However, some components may alternatively, or also, experience axial loads such that a sleeve or component may slide along a shaft. Keys do not always effectively prevent both rotation and sliding of one component relative to the other—they are most effective at resisting torsional loads. Further, keys add complexity and cost to manufacturing, may weaken critical parts, as well as being difficult to position and insert.

Hence there is a need for an alternative to the use of keys for increasing the tightness and resistance, of a shrink fitted union, to relative movement of the components.

Accordingly there is a need to provide a method for improving the resistance of components having a shrink fitted union to move relative to each other.

Accordingly, it is an object of the present invention to address the above problems.

At the very least it is an object of the present invention to provide the public with a useful alternative choice.

Aspects of the present invention will be described by way of example only and with reference to the ensuing description.

### GENERAL DESCRIPTION OF THE INVENTION

According to one aspect of the present invention there is provided a method for improving the union between two shrink-fit fitted components, said method comprising:
i) ensuring that in at least a first of said two components there is a roughened area present for at least part of the area contacted by the second component;
ii) assembling the components by a thermal shrink-fit technique so that there is deformation of either of both of
   a) the surface contacting portion of said second component into said roughened area of the first component, and
   b) an intermediate layer between said second and first components into said roughened area of at least said the first component.

According to another aspect of the present invention there is provided a method, substantially as described above, in which the contacting portion of one component is softer than the contacting portion of the other component.

According to another aspect of the present invention there is provided a method, substantially as described above, in which the roughened area, when only one component has a roughened portion, is harder than the contacting surface of the other component.

According to another aspect of the present invention there is provided a method, substantially as described above, in which one of said two components has a surface layer of a softer material.

According to another aspect of the present invention there is provided a method, substantially as described above, in which the softer material is bonded to the contacting surface of the component which is heated, or warmer, during the interference shrink fit process.

According to another aspect of the present invention there is provided a method, substantially as described above, in which said surface material is electroplated onto the component's surface.

According to another aspect of the present invention there is provided a method, substantially as described above, in which said surface material is deposited as metal particles onto the component's surface.

According to another aspect of the present invention there is provided a method, substantially as described above, in which said surface material is copper or a metal/alloy whose hardness is less than the hardness of the other component in its roughened area.

According to another aspect of the present invention there is provided a method, substantially as described above, in which said surface material is a metal or substance whose malleability is greater than or equal to the malleability of nickel.

According to another aspect of the present invention there is provided a method, substantially as described above, in which said surface material is a metal or substance whose ductility is greater than or equal to the ductility of lead.

According to another aspect of the present invention there is provided a method, substantially as described above, in which both contacting components are of a hard material, and a least one has a surface layer of a softer material.

According to another aspect of the present invention there is provided a method, substantially as described above, in which said softer surface material is bonded, welded, or brazed onto said component.

According to another aspect of the present invention there is provided a method, substantially as described above, in which said intermediate layer between said first and second components comprises a third element.

According to another aspect of the present invention there is provided a method, substantially as described above, in which said third element comprises at least one of: a sleeve, a tape, and a foil.

According to another aspect of the present invention there is provided a method, substantially as described above, in which the contacting portions of both components include roughened areas, and during fitting said intermediate element is positioned to overlap said roughened areas of both components.

According to another aspect of the present invention there is provided a method, substantially as described above, wherein the third component is of a metal, including metal alloys.

According to another aspect of the present invention there is provided a method, substantially as described above, in which a roughened area comprises a threaded portion.

According to another aspect of the present invention there is provided a method, substantially as described above, in which a roughened area comprises a pitted portion.

According to another aspect of the present invention there is provided a method, substantially as described above, in which the roughed area is formed by one or more techniques comprising: etching, abrading, deposition of particles onto a surface.

According to another aspect of the present invention there is provided a method, substantially as described above, in which the roughened area comprises cross-hatching or another pattern formed into the surface.

According to another aspect of the present invention there is provided a method, substantially as described above, in which the peaks of the highest points in said roughened area comprise the normal diameter or surface plane of the component, such that the overall average dimensions of the component in the region of the roughened surface remain the same as an equivalent component without a roughened area.

According to another aspect of the present invention there is provided a method, substantially as described above, in which the roughened area comprises recessed features formed into the surface of the component, and which recessed features do not comprise more than 95% of the surface area in the roughened area.

According to another aspect of the present invention there is provided a method, substantially as described above, in which the average depth of recessed features in a roughened area is 0.25 mm or less.

According to another aspect of the present invention there is provided a method, substantially as described above, in which one of the components is cylindrical or conical in general configuration in the general region to which a second component is to be shrink fitted.

According to another aspect of the present invention there is provided a method, substantially as described above, in which one of said components comprises a piston.

According to another aspect of the present invention there is provided a method, substantially as described above, in which one or more components are of a plastics material.

27. An assembly of shrink-fitted components assembled according to a method as claimed in any one of claims 1 through 26.

According to a further aspect of the present invention there is provided a component for shrink fit assembly modified for use according to a method substantially as described above.

In simple terms the invention comprises forming at least one ‘roughened’ area into at least part of the contacting portions of one of the components (for simplicity of description we shall refer to two components being shrink-fit assembled). Where the surface of the contacting portion of one component is substantially harder than the contacting portion than the other, then generally the roughened area is present in the harder surface. If an intermediate sleeve is used, typically of a softer material than the contacting portions of either component, then typically both contacting surfaces have roughened portions.

A roughened area generally means a surface which is not smooth. Roughening may comprise many types of features, but generally comprises pits, grooves, and/or other recesses into the surface of the component in the roughened area. Preferably also, these depressions or recesses do not cover the entire area of the roughened area—to do so would affect the overall dimensions of the component with unwanted consequences. For instance, if the component was a shaft, 100% depressions in the roughened area would reduce the diameter of the shaft in this region, thereby affecting the integrity of the union. Ideally, depressed areas comprise less than 95% of the surface area of the roughened portion.

In practice, the depressions of the roughened area are to form a ‘key’ for the surface of the other component, or an intermediate element, to interact with. Hence a variety of depressions could be used. Concentric or helical threads would be very effective at reducing axial sliding of components where one was a shaft, and can be relatively easy to machine onto the outer surface of cylindrical faces. Longitudinally oriented grooves would be effective at maximising resistance to rotational sliding of one component to the other. Cross hatching, random patterns of depression, and various non-aligned patterns can provide resistance to both axial and rotational movement. Random roughening (such as by etching, abrasive roughening (e.g. sand blasting and equivalents)) can also be very effective at providing resistance against relative axial and rotational movement of fitted components.

Taking the example of an annular component fitted to a shaft of a harder material, where axial load is to be reduced:
a thread is formed in the intended contacting region of the components. This may be formed before the shaft is surface hardened. The depth of the thread is typically around 0.1 mm.
The outer component may be of a softer material, such as a mild steel. This is heated so that its internal diameter expands enough for it to be fitted over the shaft according to conventional techniques.
Upon cooling the inner contacting surface of the outer component comes into tighter contact with the roughened area of the shaft. At this point the surface of the softer material begins to deform and key into the roughened area of the shaft—particularly as the outer softer material is heated and is more susceptible to mild deformation. The result is a union which is resistant to movement (axial, longitudinal, or both—depending on the nature of the roughened surface). It is also fluid tight, which has advantages in many potential applications.

Where two hardened components are fitted (we will again use the example of an outer component over a shaft) there are at least two options. One is to form roughened areas in both components and to insert a sleeve (which may be quite thin) of a softer material between the components. As the outer component cools, the softer material is squeezed and sandwiched so it keys with the roughened areas of both components.

Fitting an additional component may be difficult in some instance, so another option is to provide a surface of a softer material on one of the components, e.g. the outer component. This may be bonded, welded, brazed (etc.) to the component, though another option is to electroplate one or more layers of a soft material onto the component. Ideally the thickness of this layer is at least 30%, and ideally at least 60% of the average depth of the depressions in the roughened area with which it will interact.

Various other embodiments are possible. The same examples can also work if the shaft is cooled, rather than the outer component being heated.

### DESCRIPTION OF DRAWINGS

FIG. 1a-c are diagrammatic drawings illustrating a preferred embodiment of a piston shrink fitted to a shaft,

FIGS. 2a-b are diagrammatic views of an embodiment of the present invention applied to a tapered joint, and

FIG. 3 is a cross-sectional view of an embodiment using a sleeve.

### DESCRIPTION OF PREFERRED EMBODIMENT

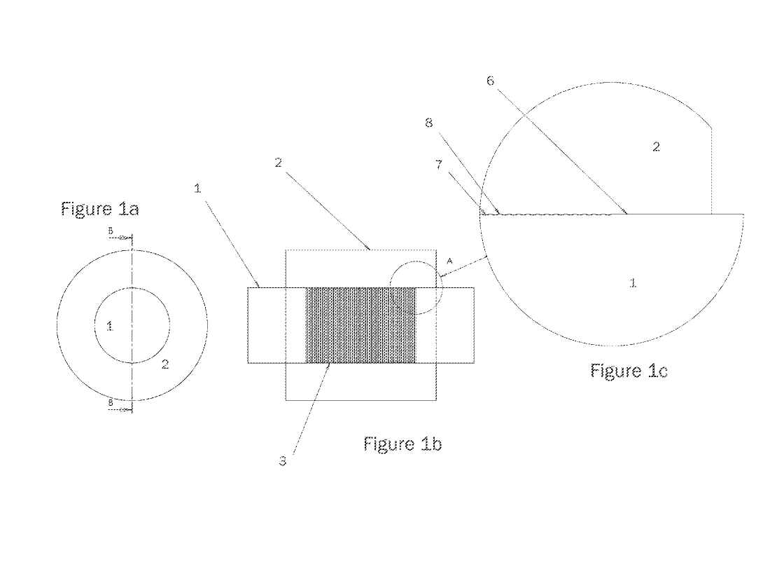

FIGS. 1a-c illustrate a preferred embodiment of a piston of mild steel (2) fitted to a hardened shaft (1). Concentric grooves (3) are formed into the shaft to create a roughened keyed area. This may be performed pre- or post-hardening of the shaft.

In this embodiment, for example, for a 40 mm diameter shaft use a 0.1 mm fit with grooves 0.04 mm deep (0.08 mm diametrical) and 0.4 mm pitch. This leaves 0.1 mm of original shaft diameter.

For a 60 mm diameter use 0.15 mm fit with 0.06 mm with 0.6 mm pitch with, again, 0.1 mm original material left on shaft. This can be performed using a standard cutting tool with a 0.4 mm radius.

For this embodiment, typically the maximum depth would be limited to 0.15 mm deep on 150 mm and larger shafts, but there is no actual limit. Ideally we do not exceed the “Fit” so the components are always held tight.

The outer piston (2) is heated and slid over the shaft (1) using standard interference fit techniques. In FIG. 1c we can see how the softer piston (1) has deformed (7) into the roughened/keyed portion (8) of the shaft (1). Also noted is a smooth outer portion (6) where no roughening has occurred. This is optional, but may be preferred where the joint may be subjected to fluid under high or very pressures, to help ensure fluid tightness—in case small voids in the roughened sections (7-8) allow fluid to leak through.

Plating one of the faces with a soft material (e.g. copper, etc.), or using an intermediate sleeve, may help improve fluid tightness. Ideally a metal which is readily deformable, ductile and/or malleable can help better seal voids and depressions in the roughened sections. Certain ductile and malleable materials can also be self healing if there is occasional relative movement between the shaft and piston (e.g. through high environment stresses such as force and loads, or high temperatures causing expansion). Consideration, though, needs to be given as to whether the malleable metal can withstand the forces between piston and shaft—this will be influenced by the nature of the metal, and the thickness and dimensions of the roughened sections and of the intermediate metal layer. Ideally, some trial and experimentation would be needed to optimise a particular combination to a specific application—particularly in high stress applications.

Typically, intermediate metals (and sleeves) may be considered whose malleability is equal to, or exceeds, that of nickel. Intermediate metals (and sleeves) may be considered whose ductility is equal to, or exceeds, that of lead. Metals outside of this range may be considered in specific applications having special criteria (e.g. high thermal conductivity requirements, resistance to pressure deformation, high electrical conductivity requirements, insulating (thermal or electrical) requirements, fluid tightness under very high pressures, high temperature operating range requirements). It is also noted that the intermediate sleeve or layer need not be restricted to metals and metal alloys—certain polymers may also be considered.

Intermediate layers and sleeves of more than one material may be considered also—e.g. dual and multiple layers, or layers made up of particles of more than one material; for instance particles of more than one metal (or other substance) may be deposited. These may also be chosen such that their boundary layers interact when subjected to the pressure of interference fitting, and/or through stresses of use of the joined components—such as to further strengthen the join, become more malleable, etc. at specific points where certain stresses occur.

Please note that while the above description relates to the illustrated piston and shaft arrangement, the same principles can be applied to other joined components, such as typically joined by an interference fit.

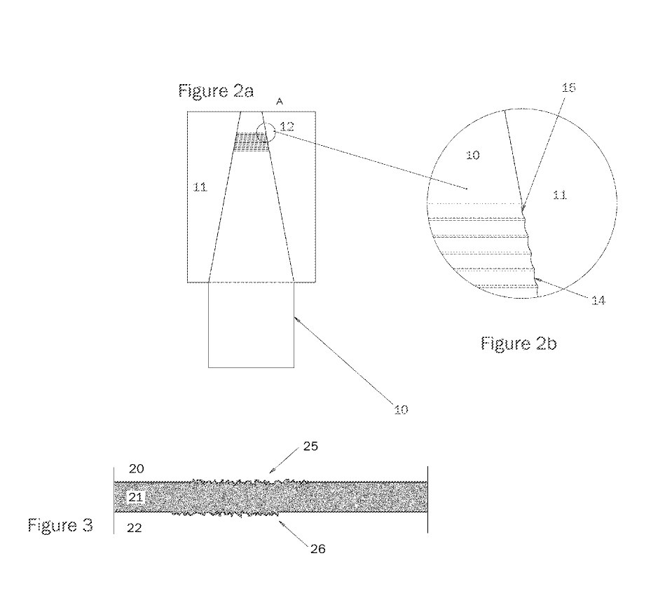

In FIGS. 2a-d the principle is illustrated in relation to a tapered joint. The same general principles apply.

A tapered shaft (10) of a harder material is fitted into a conical recess in a softer outer component (11)—where both are of a hard material then an intermediate sleeve or soft metal coating on either or both components (10,11) in the roughened area (12) can be used. Helical recesses (15) are machined into part of the outer surface of the shaft (10)—one representative profile is illustrated in FIG. 2b. Again the dimensions used in the examples of FIG. 1 can be used as a guide, though typically grooves and/or recesses will be 0.9 mm or less for most applications of this invention, and ideally 0.5 mm or less.

The outer component (11) is heated and fitted to the tapered shaft (10). The heated softer inner interior (15) of the outer component (11) deforms to fit to the grooves (14) of the shaft (10). The result is a fit which resists torsional loads (if the grooves are helically aligned or cross-hatched) as well as axial loads—something difficult for tapered shafts.

In FIG. 3, an intermediate sleeve is shown in partial cross-section between two joined components. The first component (20) has a roughened portion (25) on its surface which roughly coincides (but need not for all applications) with a roughened portion (26) on the second component (22). An intermediate sleeve (21) is positioned between the two (20, 22) prior or during interference fitting. Typically this will be fitted over the inner component, or non-heated component, whatever is easier.

The sleeve 21 may be relatively thick (0.2 mm or thicker) so they can be readily handled and slid over components. However, an alternative is to use a tape or foil and wrap or layer it about/on one component so as to form an impromptu sleeve in situ. Spray on metal deposition coatings are another option (e.g. fine metal particles in a carrier which evaporates).

Referring again to FIG. 3, as the first component is heated, placed, and shrinks the intermediate layer deforms to key with the roughened areas of both components (20,22). The result is a bonded shrink-fitted interference joint in the manner of the examples of FIGS. 1 and 2.

In all embodiments a surface coating (e.g. from electroplating or other metal deposition process) may be applied to the non-roughened contacting surface. This is particularly true if that component is a hardened material (or has a hardened surface) unlikely to deform to key with the roughened area during the shrink-fit process. A variety of deposition techniques are available—some representative examples have been given herein.

Aspects of the present invention have been described by way of example only and it should be appreciated that modifications and additions may be made thereto without departing from the spirit or scope of the present invention as described herein.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being authoritative disclosure on the true state of the prior art but rather as referencing considerations brought to the mind and attention of the inventor.

1-29. (canceled)

30. A method for improving the union between two shrink-fit fitted components, said method comprising:
i) ensuring that in at least a first of said two components there is a roughened area present for at least part of the area contacted by the second component;
ii) assembling the components by a thermal shrink-fit technique so that there is deformation of either of both of
a) the surface contacting portion of said second component into said roughened area of the first component, and
b) an intermediate layer between said second and first components into said roughened area of at least said the first component.

31. A method as claimed in claim 30 in which the contacting portion of one component is softer than the contacting portion of the other component.

32. A method as claimed in claim 31 in which the roughened area, when only one component has a roughened portion, is harder than the contacting surface of the other component.

33. A method as claimed in claim 30 in which one of said two components has a surface layer of a softer material and in which the softer material is bonded to the contacting surface of the component which is heated, or warmer, during the interference shrink fit process.

34. A method as claimed in claim 33 in which said surface material is either of:
(i) electroplated onto the component's surface, or
(ii) deposited as metal particles onto the component's surface.

35. A method as claimed in claim 33 in which said surface material is copper or a metal/alloy whose hardness is less than the hardness of the other component in its roughened area.

36. A method as claimed in claim 33 in which said surface material is a metal or substance of which either or both:
(i) its malleability is greater than or equal to the malleability of nickel, and
(ii) its ductility is greater than or equal to the ductility of lead.

37. A method as claimed in claim 33 in which both contacting components are of a hard material, and a least one has a surface layer of a softer material.

38. A method as claimed in claim 33 in which said softer surface material is bonded, welded, or brazed onto said component.

39. A method as claimed in claim 30 in which said intermediate layer between said first and second components comprises a third element.

40. A method as claimed in claim 39 in which said third element comprises at least one of: a sleeve, a tape, and a foil; said third element being of a metal

41. A method as claimed in claim 30 in which a roughened area comprises a threaded portion.

42. A method as claimed in claim 30 in which a roughened area comprises a pitted portion, in which the roughed area is formed by one or more techniques comprising: etching, abrading, deposition of particles onto a surface.

43. A method as claimed in claim 30 in which the peaks of the highest points in said roughened area comprise the normal diameter or surface plane of the component, such that the overall average dimensions of the component in the region of the roughened surface remain the same as an equivalent component without a roughened area.

44. A method as claimed in claim 30 in which the average depth of recessed features in a roughened area is 0.25 mm or less.

45. A method as claimed in claim 30 in which one of the components is cylindrical or conical in general configuration in the general region to which a second component is to be shrink fitted.

46. A method as claimed in claim 30 in which one of said components comprises a piston.

47. A method as claimed in claim 30 in which one or more components are of a plastics material.

48. An assembly of shrink-fitted components assembled according to a method as claimed in claim 30.

49. A component for an assembly of shrink-fitted components as claimed in claim 30, modified for use in said shrink fit assembly according to the method of claim 30.
